(19) United States
(12) Patent Application Publication
(10) Pub. No.: US 2016/0265223 A1
(43) Pub. Date: Sep. 15, 2016

(54) SUSPENDED CEILING SYSTEM AND TILE THEREFORE

(71) Applicant: 9290-9043 QUÉBEC INC., Saint-Henri-de-Lévis (CA)

(72) Inventors: Eric Laganiere, St-Henri de Lévis (CA); Adrien Cloutier, Saint-Anselme (CA); Dominic Vallee, Levis (CA)

(73) Assignee: 9290-9043 Quebec Inc., Quebec (CA)

(21) Appl. No.: 15/030,396

(22) PCT Filed: Oct. 31, 2014
(86) PCT No.: PCT/CA2014/051047

§ 371 Date: Apr. 19, 2016

Related U.S. Application Data
(60) Provisional application No. 61/898,823, filed on Nov. 1, 2013.

(51) Int. Cl. E04B 9/04; B27H 1/00; B32B 3/30; B32B 21/02; E04B 9/10; B32B 3/04

(52) U.S. Cl. CPC E04B 9/0478; E04B 9/0435; E04B 9/045; E04B 9/0428; E04B 9/10; B32B 3/04; B32B 3/30; B32B 21/02; B27H 1/00; B32B 2307/514; B32B 2419/00

(57) ABSTRACT

The tile for a suspended ceiling system generally has a folded sheet of a high-pressure laminate material having a rectangular shape, the tile having at least a backing layer on an inside face and an externally visible decorative layer; the tile having a pair of opposite longitudinal edges and a pair of opposite transversal edges, the edges of at least one of the two pairs having at least one inward fold rigidly projecting from the inside face, and can be used as structure to be held by support members of a ceiling.

### BACKGROUND

Suspended ceiling systems (sometimes referred to as dropped ceiling systems or false ceiling systems) are well known in the art. These systems are generally used as secondary ceilings which are suspended below the structural ceiling of a house or a building, hence allowing wiring, piping and other services to be incorporated in the plenum space, i.e. the volume between the suspended ceiling and the structural ceiling.

Such suspended ceiling systems generally incorporate tiles which can be supported by the structural ceiling via longitudinal and transversal support members, typically having an inverted “T” shape. During use, each of the edges of the tiles are removably laid on associated support members. Thus, offering an access to the plenum space, as opposed to permanent ceiling systems.

The tiles have a flat rectangular shape and are often made of a fiberboard material. Properties such as fire resistance, flame retardation, sound absorption and attenuation are features which are sought in materials for ceiling tiles.

Although existing suspended ceiling systems were satisfactory to a certain degree, there remained room for improvement, particularly in terms of offering a broader range of textures and finishes, reducing the cost of the tile and the cost associated with its installation.

### SUMMARY

On the other hand, it was well known to use high-pressure laminate materials to make protective and decorative surfaces of countertops. To this end, a high-pressure laminate (HPL) was adhered to a substrate material of the countertop.

When applied on a curved shape substrate, so-called postforming grades HPL, was heated then flexed to adopt the shape of the substrate, which then acted as a mold to maintain the shape and support the flexed high-pressure laminate. This was done within a certain temperature range, at which the high-pressure laminate material was flexed only along a predetermined axis and during a predetermined time window. Once the time window is past, the material keeps the shape of the substrate thereunder.

It was discovered that at least some postforming grade HPLs had sufficient structure to allow free-standing folds, and that these folds could be used as structure to be held by support members of a ceiling. Moreover, it was found that contrary to the known paradigm associated with flexing the postforming grade HPLs material along the predetermined axis, the free-standing folds of the postforming grade HPLs could be formed along both the predetermined axis and at least another axis perpendicular thereto.

Henceforth, in accordance with one aspect, there is provided a tile made of HPL material having a transparent layer on an outside face, a backing layer on an inside face and a decorative layer therebetween. By using such a material for a tile, one can choose between a broad choice of colors, textures and finishes.

In accordance with another aspect, there is provided a use of HPL material that avoid the step of adhering the HPL material to the substrate. Therefore, costs associated to man hours are reduced since no adhering process has to be performed.

In accordance with another aspect, there is provided a tile for a suspended ceiling system, the tile comprising a folded sheet of a high-pressure laminate material having a rectangular shape, the tile having at least a backing layer on an inside face and an externally visible decorative layer; the tile having a pair of opposite longitudinal edges and a pair of opposite transversal edges, each of the edges of at least one of the two pairs having at least one inward fold rigidly projecting from the inside face.

In accordance with another aspect, there is provided a kit of parts for assembling a suspended ceiling system, the kit of parts comprising: a plurality of tiles comprising a folded sheet of a high-pressure laminate material having a rectangular shape, the tile having at least a backing layer on an inside face and an externally visible decorative layer; the tile having a pair of opposite longitudinal edges and a pair of opposite transversal edges, each of the edges of at least one of the two pairs having an inward fold rigidly projecting from the inside face; and a plurality of runners to be fixed on a ceiling, each runner having a body being longitudinally elongated and having a clamping channel adapted to tightly receive the inward fold of one of the opposite longitudinal edges, the clamping channel applying a compressive pressure to the received longitudinal edge to hold it therein.

In accordance with another aspect, there is provided a tile for a suspended ceiling system, the tile comprising: a folded sheet of a high-pressure laminate material, the tile having a decorative facing and an opposite internal backing; the tile having at least one pair of edges, each of the edges of the at least one pair having at least one inward fold rigidly projecting from the inside face.

In accordance with another aspect, there is provided a method of forming a free-standing fold in a tile of a high-pressure laminate material, the method including the steps of: uniformly applying heat to both the inside face and the outside face of the tile at the region of the fold; and folding the tile along the heated fold.

Many further features and combinations thereof concerning the present improvements will appear to those skilled in the art following a reading of the instant disclosure.

### DESCRIPTION OF THE FIGURES

In the figures,

FIG. 1A is a view of an example of a sheet of a vertical postforming grade (VGP) standard high-pressure laminate material while FIG. 1B emphases on a recessed portion of the junction between a longitudinal edge and a transversal edge of the sheet;

FIG. 2 is an oblique view showing an example of a tile having free-standing folds;

FIG. 3 is an oblique view showing an example of a suspended ceiling system;

FIG. 4 is an oblique view showing an example of a separator;

FIG. 5 is an oblique view showing an example of an assembled suspended ceiling system;

FIG. 6 is a side view showing an alternate example of a tile being suspended on two T-shaped support members; and

FIG. 7 is a cross-sectional view of an example of a runner.

### DETAILED DESCRIPTION

High-pressure laminate (HPL) material is a material generally used to cover walls and/or work surfaces such as counters, vanities, tables and desks. Standard HPL material can consist of a backing layer, a decorative layer, and a transparent layer that allows to see the decorative layer thereunder. The backing layer generally has multiple layers of kraft paper impregnated with phenolic resins which give strength and rigidity to the material. The decorative layer, disposed between the backing layer and the transparent layer, is designed to be appealing to the eye by exhibiting wood grains, patterns or solid colors. The decorative layer is then covered by a melamine impregnated layer. Then, these layers are combined into a rigid sheet of material under the effect of high-pressure and high-temperature. It is contemplated that standard HPL material can have various textures and finishes which can be obtained by imparting a pressure pattern during forming of the exterior, transparent layer, for instance.

The material is generally sold in the form of sheets having dimensions of 8′×4′, or 30″×12′, for instance, and have thicknesses varying from 0.028″ to 0.045″. There are currently many standard HPL material manufacturers, each manufacturing sheets of HPL material products at competitive prices and having the latest trends impregnated onto the decorative layer of HPL material. Amongst all the manufacturers, one may consider the following: Formica™, Arborite®, Wilsonart®, Pionite™, for instance. Each of these manufacturers can provide specifications relating to fire resistance, flame retardation, sound absorption and attenuation, which are features that are desirable in a tile used in suspended ceiling systems. For these reasons, using HPL material in a suspended ceiling system is advantageous.

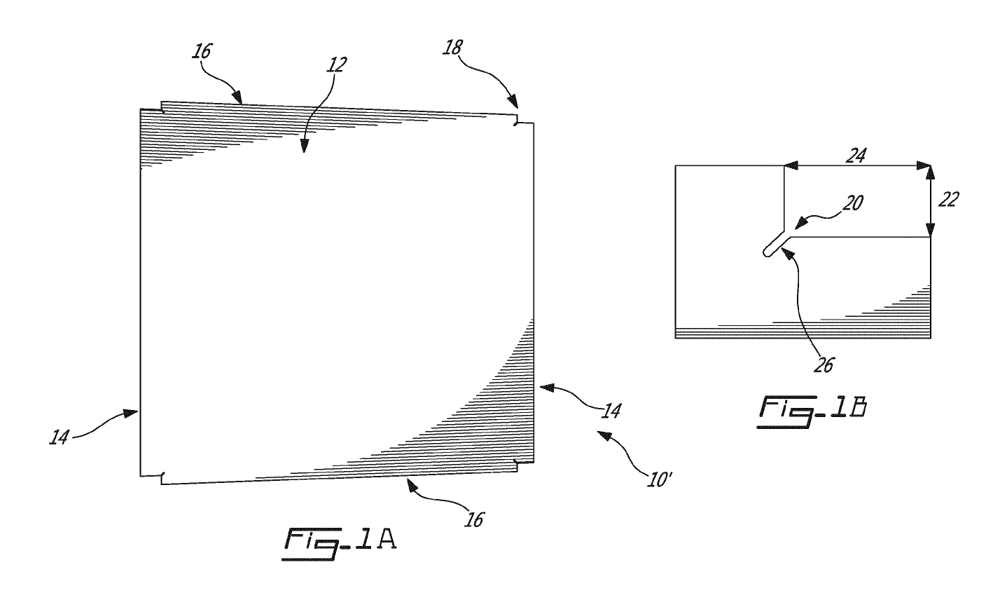

FIG. 1A shows an example of a unfolded tile 10′ made of a standard HPL material, the tile having an outside face 12. The unfolded tile 10′ can have a rectangular shape which defines two opposite longitudinal edges 14 and two opposite transversal edges 16. In this embodiment, the decorative layer shows a wood grain finish that is parallel to the transversal edges 16. FIG. 1B emphasizes a junction 18 of one longitudinal edge and one transversal edge where a recessed portion 20 is recessed from the edges. The recessed portion 20 can have a rectangular area and it can be removed with known techniques such as cutting, sawing, or laser processing, and the like. In the showed embodiment, the recessed area 20 has a longitudinal width 22 of about 0.5″ and a transversal width 24 of about 1″. When the sheet of HPL material (or the unfolded tile 10′) is to be folded into a tile 10, the recessed area 20 enables an easier and cleaner fold. In some circumstances, it can be advantageous to cut a rounded section 26 either near or into the corner of the recessed area 20. In addition to allowing easier and cleaner fold, this rounded section 26 can moderate the stress in the material which can reduce the risk of causing stress cracks during the folding step.

In the present embodiment, postforming grades of HPL material are of particular interest. According to the National Electrical Manufacturers Association's (NEMA) standard publication LD 3-2005, two grades of HPL material are characterised as postforming grades: the vertical postforming grade (VGP) and the horizontal postforming grade (HGP). Moreover, other grades of HPL material (HGS, HGL, VGS, VGL) can be postformed, as advertised by some manufacturers. Therefore, many grades can be suitably chosen for the instant embodiment. However, since the VGP and the HGP are generally thinner than the HGS, for instance, VGP and HGP are preferred in the embodiment presented herein. Also, it is known that postforming grades of HPL material can be permanently and rigidly bent to follow substrates having curved shapes or sharp edges. These so-called postforming grades HPLs can be heated to 300-325° F., or at any folding temperature range specified by the manufacturer, to obtain optimal conditions for bending and flexing. After cooling, the folded sheet of HPL keeps the shape of the substrate thereunder. In the present embodiment, the postforming grade HPLs are used without a substrate. In other words, the sheet of HPL are folded to form a free-standing fold (or flange), for instance. It has been found that these free-folding folds offer a structure sufficiently rigid to be used without the substrate thereunder.

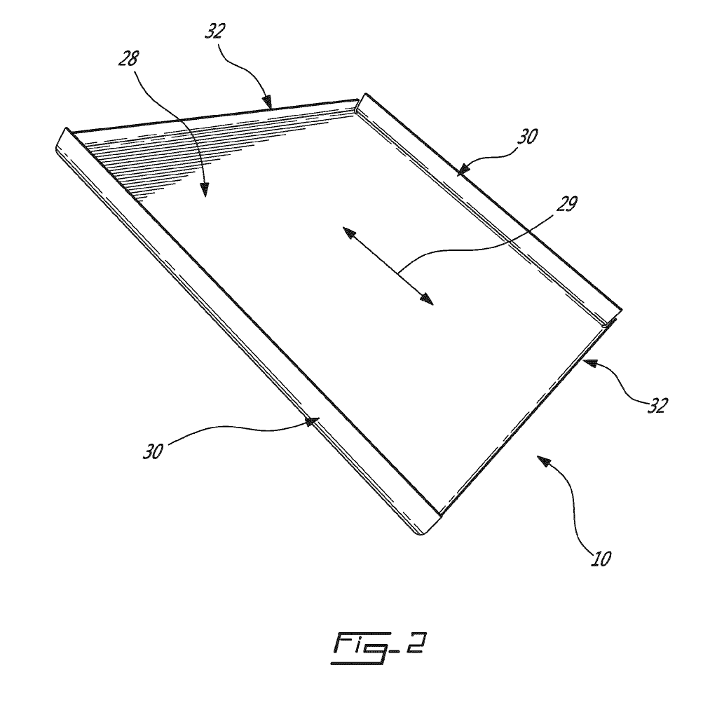

FIG. 2 shows an oblique view of the inside face 28 of a tile 10. In this embodiment, the tile 10 has been heated and folded in accordance with the procedure associated with commercially available postforming grades standard HPLs. Indeed, the opposite longitudinal edges have been folded to form longitudinal free-standing folds 30, and the opposite transversal edges have been folded to form transversal free-standing folds 32. It will be readily understood that the fold of each of the longitudinal edges 14 can be used for fixation while the fold of each of the transversal edges 16 can reinforce the structure of the tile 10. Generally, these folds can give sufficient structure to limit an undesired transversal curve to develop when the tile 10 is installed on a ceiling 34. Such tiles 10 can have the dimensions of 23″×23″, or smaller dimensions like 11″×11″, for instance. Still, tiles 10 having larger or smaller dimensions can be obtained.

Still referring to FIG. 2, it is noted that although the free-standing folds 32 form an orthogonal angle with the inside face 28 of the tile 10, the angle between the free-standing folds 32 and the inside face 28 can also be acute and/or obtuse. In this situation, the interstice 44 of the runners 38 are adapted to receive the acute and/or the obtuse angle of the free-standing folds 32.

Moreover, it is noted that the HPL material of the tile 10 typically has a grain orientation 29. In the embodiment of FIG. 2, the longitudinal free-standing folds 30 are formed along the grain orientation 29 while the transversal free-standing folds 32 are formed orthogonal to the grain orientation 29. Although folding the HPL material along a predetermined axis along the grain orientation 29 of the HPL material was generally preferred, it was found that folding of the HPL material can also be performed along at least an axis which is not the predetermined axis, i.e. orthogonal to or simply against the grain orientation 29, can yield acceptable free-standing folds. To do so, especially at small radii, care must be given to the steps of heating and folding, especially in the situation where the free-standing fold is to be formed against the grain orientation 29. Indeed, it was found that providing uniform heating to the unfolded tile 10′ prior to the step of heating could yield satisfactory free-standing folds and thus prevent the HPL material from cracking and blistering. In one embodiment, heat is applied on the fold region simultaneously from the inside face 28 and from the outside face 12 of the unfolded tile 10′ prior to the step of folding the free-standing fold against the grain orientation 29 can be used to provide such uniform heating.

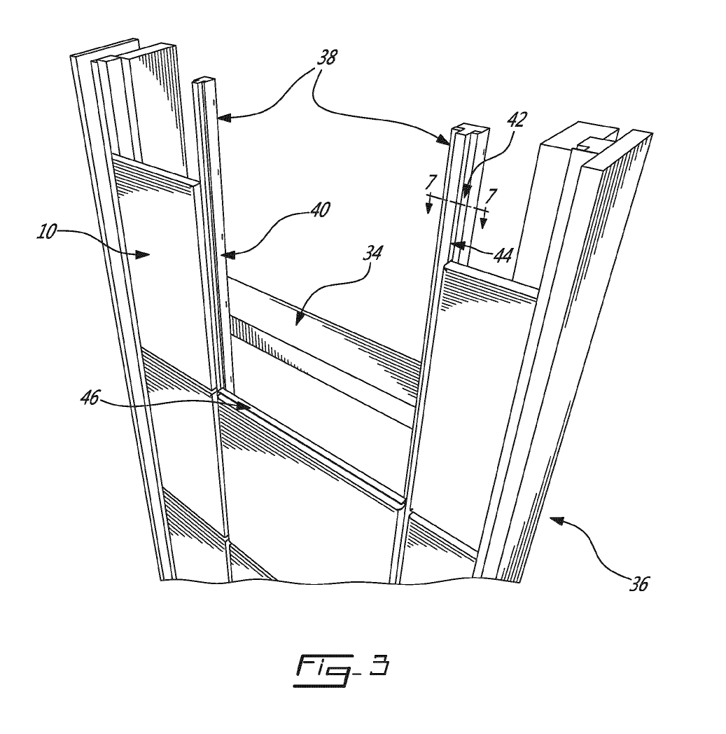

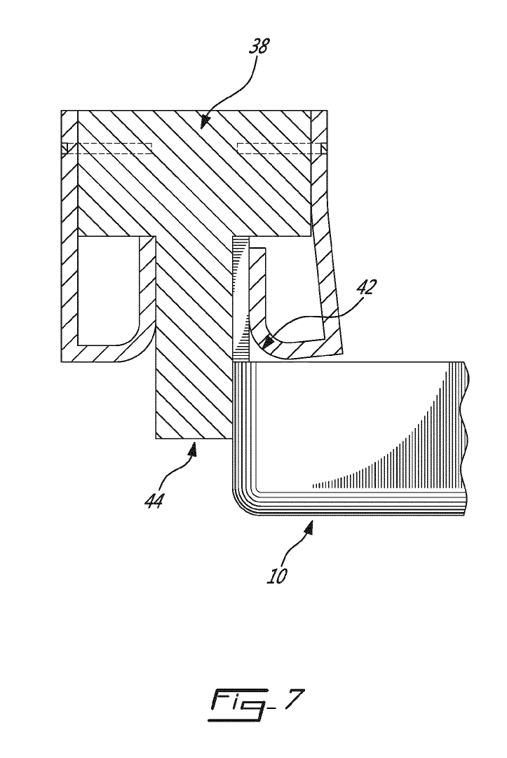

FIG. 3 shows an example of a suspended ceiling system 36 in accordance with the instant embodiment. The suspended ceiling system 36 have runners 38 (or support members) which are fixed on a ceiling 34 in a parallel manner. These runners 38 can have a longitudinally elongated body 40 and can have clamping channels 42 along a longitudinal axis. As also seen in FIG. 7, the tiles 10 can be fixed to the runners 38 by inserting the free-standing folds of the longitudinal edges 14 of the tile 10 along into the clamping channels 42 of two adjacent runners, thereby securely fixing the tile 10 indirectly to the ceiling 34.

An interstice 44 having a distance spacing can be provided between two parallel clamping channels of the runner 38. Typically, the distance spacing between two clamping channels can vary from 0″ to 2″. In the embodiment where the distance spacing is null, two adjacent tiles can be closely adjoined. In another embodiment, where the distance spacing is 2″, for instance, a decorative finish can be provided on the surface of the interstice, thus providing a look appealing to the eye. In the example of FIG. 3, the interstice 44 is characterized by a black color, which can offer an appealing look to the suspended ceiling system 36.

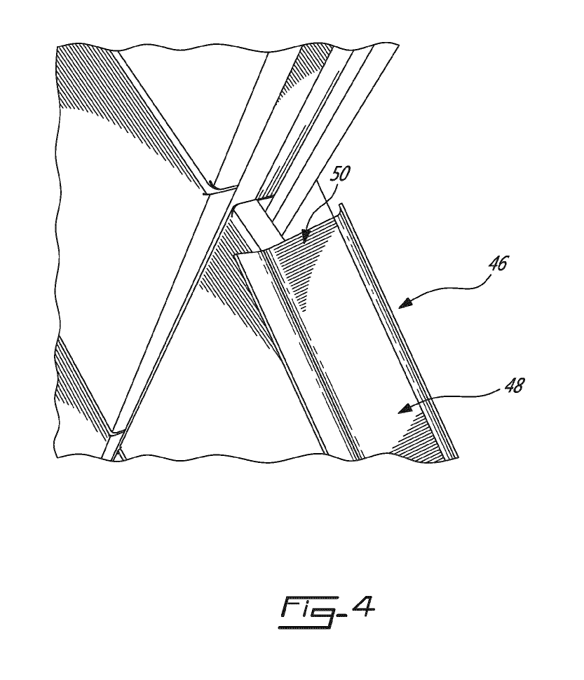

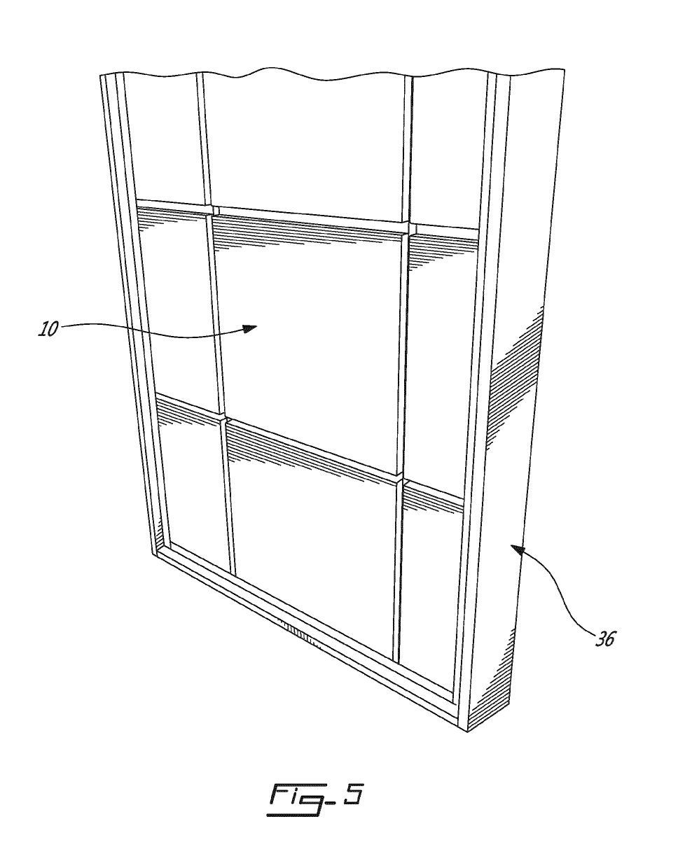

FIG. 4 shows an example of a separator 46, which is used to separate two longitudinally adjacent tiles. The separator generally has a transversely elongated body 48 that has two endings 50 and corresponding locking elements located at each endings. Each of the locking elements can be fixed directly to the body 40 of the runner 38 or to its clamping channel. In the case where the separator 46 has a longitudinal width equals to the spacing distance of the runner, the tile can be equally spaced either longitudinally and transversally, as shown in the embodiment of FIG. 5. In another embodiment, the separator 46 can be simply deposited on two longitudinally adjacent tiles in order to separate them. Thus, fully standing on longitudinally adjacent tiles instead of standing on two adjacent runners.

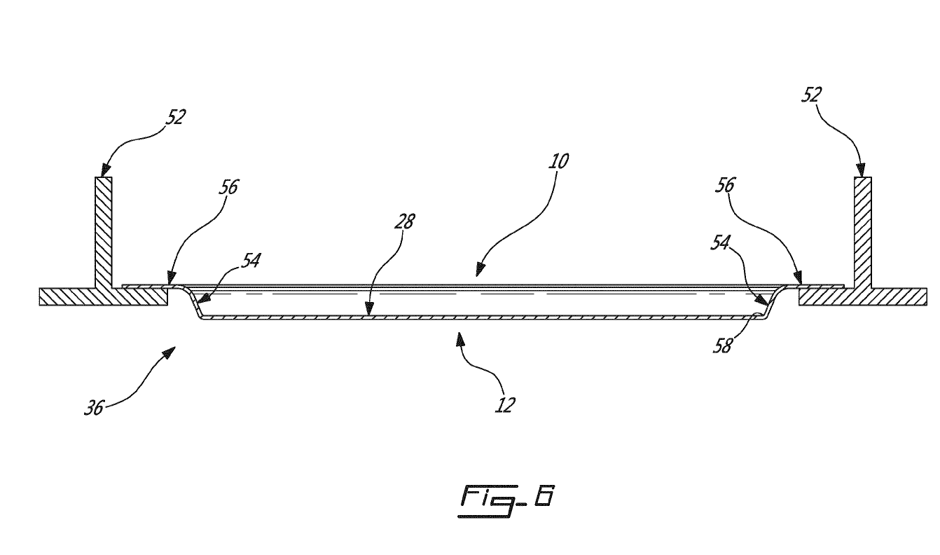

FIG. 6 shows a side view of a section of another embodiment of a tile. In this embodiment, the tile is designed to be retrofitted in suspended ceiling systems using T-shaped transversal and longitudinal support members 52. In this system, the tiles are removably suspended by the support members 52 as they are laid thereonto. For instance, each edge of the tile has a first inward fold 54 perpendicular to the inside face 28 and a second outward 56 fold perpendicular to the first fold 54. Here also, the tile 10 may have recessed portions recessing from the opposite longitudinal edges and from the opposite transversal edges in order to be easily folded into the free-standing folds. With this kind of tile, former tiles of a suspended ceiling systems having damaged or average looking tile can be replaced by tiles having various kind of finishes and textures following the latest trends. As shown in FIG. 6, the free-standing folds 54 project from the inside face 28 and the free-standing folds 56 project, in turn, from the free-standing folds 54. It is noted that although the first inward fold 54 form a first obtuse angle with the inside face 28 and that the second outward fold 56 form a second obtuse angle with the first inward fold 54, these obtuse angles can also be orthogonal and/or acute in other embodiments.

FIG. 7 shows a cross-sectional view of the runner 38, for instance, along section 7-7 shown in FIG. 3. Referring to FIG. 7, it is noted that the tile 10 is to be fixed into the clamping channel 42 of the runner 38. The clamping channel 42 generally have a hollow space where a free-standing fold of the tile 10 can be inserted to a certain depth. Once in position in the clamping channel, the free-standing fold is maintained therein by a compressive force of the clamping channel exerted simultaneously on the outside face 12 and on the inside face 28 of the free-standing fold. It will be understood that there are other ways of removably fixing the tile 10 in support members attached to ceilings. Particularly, the free-standing folds can have locking members such as outwardly or inwardly protruding teeth, cams or barbs incorporated along the longitudinal axis which can be locked or clipped in a corresponding slots of the clamping channel.

Standard HPL material manufacturers generally provide, for each type of HPL product, a postform minimum radius which represents the minimum radius the material can be folded to. Although some manufacturers advertise a sheet of HPL having a thickness of 0.028″ that can be bent to a postform minimum radius of 5/16″ for the outside face, the American National Standards Institute (ANSI) and the National Electrical Manufacturers Association's (NEMA) standard publication LD 3-2005 suggest to bend the VGP HPL to a postform radius of no less than ½″, and suggest to bend the HGP HPL to a postform radius of no less than ⅝″. However, it has been shown that the sheet of HPL can be folded to radii 58 (as showed in FIG. 6) smaller than ¼″ in order to form the free-standing folds. By folding the HPL material at such small radii, some specific looks of the suspended ceiling systems can be obtained.

As is has been described above, the HPL material can be provided in the form of standard HPL having a transparent layer, a backing layer and a decorative layer in-between. It is readily understood, however, that a non-standard HPL material can also be used to make the tile described herein. Indeed, the non-standard HPL material can simply consist of a backing layer having a decorative layer standing thereon. In other words, the non-standard HPL can consist of a standard HPL material lacking the transparent layer applied on the decorative layer of standard HPL material.

As can be seen therefore, the examples described above and illustrated are intended to be exemplary only. The suspended ceiling system described herein has been extensively described in applications for ceilings, however, it is readily understood that the described embodiments can also be used as any surface-covering systems which needs removable tiles to be held by support members attached on the surface, such as wall-covering systems, for instance. Moreover, tiles having a triangular body or a body having a plurality of edges can be considered suitable for the tile described herein. The scope is indicated by the appended claims.

1. A tile for a suspended ceiling system, the tile comprising a folded sheet of a high-pressure laminate material having a rectangular shape, the tile having at least a backing layer on an inside face and an externally visible decorative layer; the tile having a pair of opposite longitudinal edges and a pair of opposite transversal edges, each of the edges of at least one of the two pairs having at least one inward fold rigidly projecting from the inside face.

2. The tile of claim 1, wherein the high-pressure laminate material has a grade, the grade being either a vertical postforming grade (VGP) or a horizontal postforming grade (HGP).

3. The tile of claim 1, wherein each of the edges of the two pairs has at least one inward fold rigidly projecting from the inside face.

4. The tile of claim 3, wherein the at least one inward fold of the edges of the opposite longitudinal edges extend from the inside face for a first length and the at least one inward fold of the edges of the opposite transversal edges extend from the inside face for a second length.

5. The tile of claim 4, wherein the first length is about 1 inch and the second length is about 0.5 inch.

6. The tile of claim 1, wherein each of the opposite longitudinal edges has two opposite ends, each of the two opposite ends having a recessed portion longitudinally recessing therefrom.

7. The tile of claim 1, wherein each of the opposite transversal edges has two opposite ends, each of the two opposite ends having a recessed portion transversally recessing therefrom.

8. The tile of claim 1, wherein each of the edges of at least one of the two pairs has a first inward fold rigidly projecting from the inside face and a second outward fold rigidly projecting from the first fold.

9. The tile of claim 8, wherein the second outward fold is supportable by a support member fixed on a ceiling.

10. The tile of claim 1, wherein the at least one inward fold has locking elements either outwardly or inwardly protruding in an interspersed manner along the at least one inward fold.

11. The tile of claim 1, wherein the at least one inward fold is folded to a postform radius smaller than 0.25 inch.

12. The tile of claim 1, wherein the decorative layer is protected by a transparent layer added on the decorative layer.

13. The tile of claim 1, wherein the inward folds of the edges of at least one of the two pairs rigidly project normal to the inside face.

14. The tile of claim 1, wherein the inward folds of the edges of at least one of the two pairs is formed against a grain orientation of the high-pressure laminate material.

15. A kit of parts for assembling a suspended ceiling system, the kit of parts comprising:
a plurality of tiles comprising a folded sheet of a high-pressure laminate material having a rectangular shape, the tile having at least a backing layer on an inside face and an externally visible decorative layer; the tile having a pair of opposite longitudinal edges and a pair of opposite transversal edges, each of the edges of at least one of the two pairs having an inward fold rigidly projecting from the inside face; and
a plurality of runners to be fixed on a ceiling, each runner having a body being longitudinally elongated and having a clamping channel adapted to tightly receive the inward fold of one of the opposite longitudinal edges, the clamping channel applying a compressive pressure to the received longitudinal edge to hold it therein.

16. The kit of parts of claim 15, wherein the high-pressure laminate material has a grade, the grade being either a vertical postforming grade (VGP) or a horizontal postforming grade (HGP).

17. The kit of parts of claim 15, wherein each of the edges of the pair of opposite longitudinal edges and of the pair of opposite transversal edges has at least one inward fold rigidly projecting from the inside face.

18. The kit of parts of claim 15 further comprising a plurality of separators, each of the separators having an elongated body and two opposite endings, each of the endings having a support element to be perpendicularly fixed to one of two adjacent runners thereby spacing two longitudinally adjacent tiles.

19. The kit of parts of claim 15, wherein the inward folds of the edges of at least one of the two pairs rigidly project normal to the inside face.

20. The kit of parts of claim 15, wherein the inward folds of the edges of at least one of the two pairs is formed against a grain orientation of the high-pressure laminate material.

21.-29 (canceled)

30. A method of forming a free-standing fold in a tile of a high-pressure laminate material, the method including the steps of: uniformly applying heat to both the inside face and the outside face of the tile at the region of the fold; folding the tile along the heated fold to form the free-standing fold.

31. The method of claim 30, wherein said folding the heated fold is done when the heated fold has a temperature within a folding temperature range.

32. The method of claim 30, wherein the free-standing fold is formed against a grain orientation of the high-pressure laminate material.
